(19) United States
(12) Patent Application Publication
(10) Pub. No.: US 2025/0141144 A1
(43) Pub. Date: May 1, 2025

(54) PACKING ASSEMBLY BODY, AND MANUFACTURING APPARATUS FOR MANUFACTURING PACKING ASSEMBLY BODY

(71) Applicant: Yazaki Corporation, Tokyo (JP)

(72) Inventors: Michihiro MORI, Makinonhara-shi (JP); Daisuke YAMANASHI, Makinohara-shi (JP); Jumpei HAYASHI, Kakegawa-shi (JP)

(73) Assignee: Yazaki Corporation, Tokyo (JP)

(21) Appl. No.: 18/901,166

(22) Filed: Sep. 30, 2024

(30) Foreign Application Priority Data
Nov. 1, 2023 (JP) 2023-187539

(51) Int. Cl. H01R 13/405; H01R 43/24

(52) U.S. Cl. CPC H01R 13/405; H01R 43/24

(57) ABSTRACT

A packing assembly body includes a terminal retaining portion having a plate-shaped terminal, a burying portion in which part of the terminal is buried, and a cylindrical portion being provided to continue with the burying portion to surround the terminal; and a ring-shaped packing that is inserted to surround the terminal from the outside and seal an internal space of the cylindrical portion, wherein an air bleeding mechanism configured to discharge air at the side of an insertion direction of the packing in the internal space to an outside is provided in the burying portion.

### TECHNICAL FIELD

The present disclosure relates to a packing assembly body, and a manufacturing apparatus for manufacturing a packing assembly body.

### BACKGROUND ART

Conventionally, there is a terminal block that is inserted into an opening hole provided in a casing of a device or the like and fastened by a bolt to the casing to establish continuity between the inside and outside of the casing (for example, see Patent Document 1). FIG. 7 is a cross-sectional view showing an example of a conventional terminal block. As an example of the terminal block, as shown in FIG. 7, it is provided with a terminal 102, a housing 106 including a burying portion 161 into which part of the terminal 102 is buried and a cylindrical portion 162 being continuous to the burying portion 161 and having an accommodation space 106S for accommodating the terminal 102, a packing 105 being inserted to surround the terminal 102 while blocking the accommodation space 106S, and a holder which is not shown in figures and assembled into this cylindrical portion 162. In such a conventional terminal block 101, the packing 105 is provided in close contact with the terminal 102 and the inner peripheral surface of the cylindrical portion 162, thereby ensuring the waterproofness.

### CITATION LIST

### Patent Documents

[Patent Document 1] JP 2010-211933A

### SUMMARY OF THE INVENTION

### Technical Problem

However, in the conventional terminal block 101, the burying portion 161 of the housing 106 is configured to be solid while burying part of the terminal 102 therein. Therefore, when the packing 105 is inserted to be outside (inserted) the terminal 102 in a state in which the terminal 102 is supported by the housing 106, a side in the insertion direction (the front side in the advancing direction) of the packing 105 in the housing space 106S becomes a sealed area 101A, and a high insertion force is required to insert the packing 105. As a result, the workability of assembling the packing 105 is poor.

An object of the present disclosure is to provide a packing assembly body configured to improve the assembly workability of the packing, and a manufacturing apparatus for manufacturing a packing assembly body.

### Solution to Problem

In order to solve the above-identified problem, an invention according to claim 1 is a packing assembly body including a terminal retaining portion having a plate-shaped terminal, a burying portion in which part of the terminal is buried, and a cylindrical portion being provided to continue with the burying portion to surround the terminal; and a ring-shaped packing that is inserted to surround the terminal from the outside and seal an internal space of the cylindrical portion, wherein an air bleeding mechanism configured to discharge air at the side of an insertion direction of the packing in the internal space to an outside is provided in the burying portion.

An invention according to claim 3 is a manufacturing apparatus for manufacturing the packing assembly body according to claim 2, including a mold for inserting the terminal to mold the terminal retaining portion; a first insert for forming the first passage and in which the terminal is inserted; and a pair of second inserts for forming the pair of second passages, wherein the pair of second inserts are provided in a rod shape, and the first insert is configured to include a cylindrical first insert main body into which the terminal is insertable, and a pair of insertion holes provided in the first insert main body and into which the pair of second inserts are inserted respectively.

### Effect of the Invention

According to the present disclosure, it is possible to improve the assembly workability of the packing.

### BRIEF DESCRIPTION OF THE DRAWINGS

FIG. 1 is a perspective view showing a terminal block according to an embodiment of the present invention.

FIG. 2 is an exploded perspective view of the terminal block.

FIG. 3 is a cross-sectional view taken along a line I-I in FIG. 1.

FIG. 4 is a view showing an enlarged view of a main portion in FIG. 3.

FIG. 5 is a view showing a manufacturing apparatus for manufacturing the terminal block.

FIG. 6 is a cross-sectional view showing a situation of using the manufacturing apparatus to manufacture the terminal block.

FIG. 7 is a cross-sectional view showing an example of a conventional terminal block.

### DESCRIPTION OF EMBODIMENTS

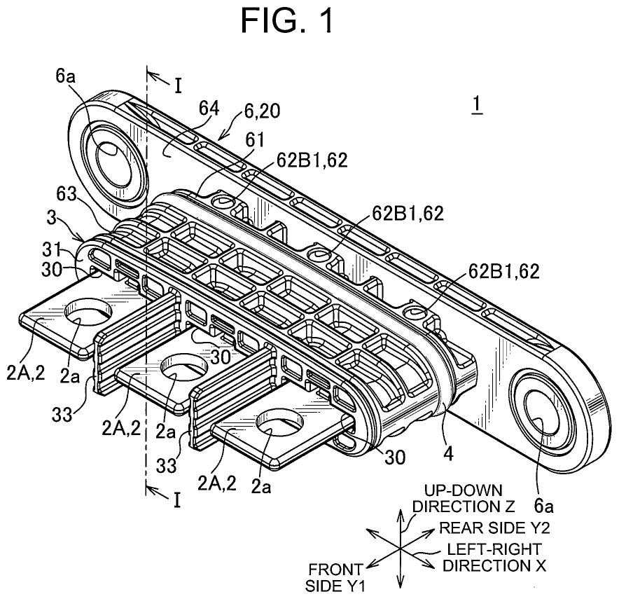

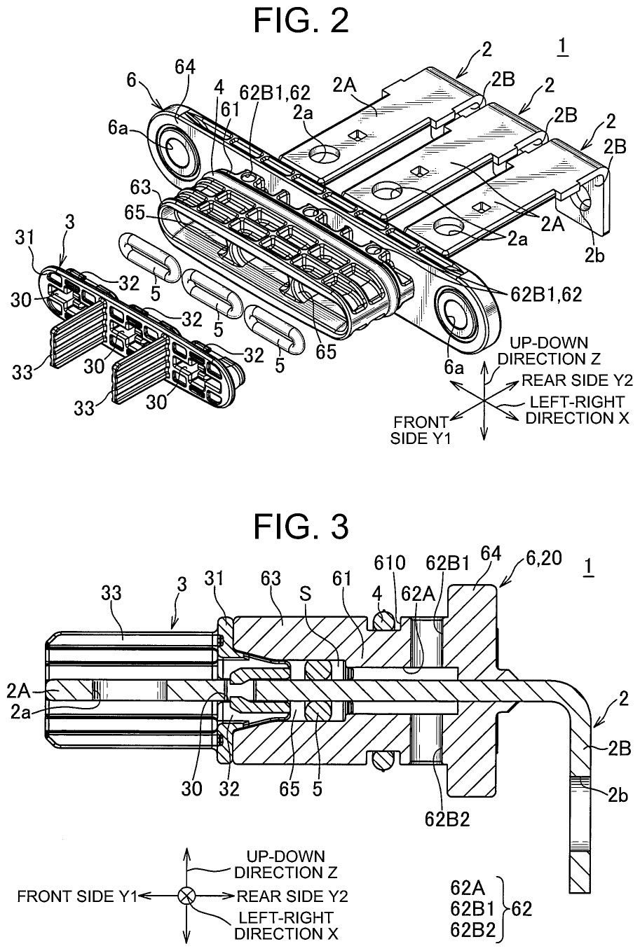

Hereinafter, an embodiment of the present invention will be described according to the enclosed figures. FIG. 1 is a perspective view showing a terminal block 1 according to an embodiment of the present invention. FIG. 2 is an exploded perspective view of the terminal block 1. FIG. 3 is a cross-sectional view taken along a line I-I in FIG. 1.

A terminal block 1 according to the present embodiment is fastened by a bolt to a support body having an assembly hole so as to make a pair of connection targets sandwiching the support body and provided outside and inside thereof to be conductive. As shown in FIG. 1 and FIG. 2, this terminal block 1 includes a terminal retaining portion 20 (shown in FIG. 1) for retaining three terminals 2, a holder 3 being assembled to this terminal retaining portion 20 to support each terminal 2, a ring-shaped packing-for-retaining-portion 4 interposed between the terminal retaining portion 20 and a peripheral edge of the assembly hole, and a ring-shaped terminal packing (packing) 5 mounted on each terminal 2. The terminal retaining portion 20 and the terminal packing (packing) 5 configure a packing assembly body.

Hereinafter, as shown in FIG. 2, a movement direction of the terminal packing 5 when it is inserted to be outside the terminal 2 may be referred to as a “front-rear direction” and may be indicated by an “arrow Y”, a direction being orthogonal to the front-rear direction Y and in which three terminals 2 are lined up may be referred to as a “left-right direction” and may be indicated by an “arrow X”, and a direction being orthogonal to the arrow X and the arrow Y may be referred to as a “up-down direction” and may be indicated by an “arrow Z”. Also, one side (the front side in FIG. 2) of the arrow Y may be referred to as the “front side Y1”, and the other side being opposite thereto (the rear side in FIG. 2, the direction in which the terminal packing 5 is inserted to be outside the terminal 2) may be indicated by the “rear side Y2”.

As shown in FIG. 1, the terminal retaining portion 20 includes three terminals 2 and a resin molded portion 6 that retains these three terminals 2, wherein these three terminals 2 are formed by insert molding in the resin molded portion 6 to be integrally formed.

As shown in FIG. 2, the three terminals 2 are provided side by side in the left-right direction X. Each terminal 2 is configured by bending a rectangular sheet metal into an L-shape, and each terminal 2 includes a horizontal plate portion 2A and an orthogonal plate portion 2B being bent at an end portion at the rear side Y2 of this horizontal plate portion 2A to extend in one side (downward) of the up-down direction Z. The horizontal plate portion 2A is provided to extend in a planar shape including the front-rear side Y and the left-right direction X, and the orthogonal plate portion 2B is provided to extend in a planar shape including the up-down direction Z and the left-right direction X. Also, a first bolt hole 2a fastened by a bolt with one of the pair of connection targets is provided in the front-end portion (the end portion being apart from the orthogonal plate portion 2B) of the horizontal plate portion 2A, and a second bolt hole 2b fastened by a bolt with the other of the pair of connection targets is provided in the lower-end portion (the end portion being apart from the horizontal plate portion 2A) of the orthogonal plate portion 2B.

As shown in FIG. 2 and FIG. 3, the resin molded portion 6 includes a burying portion 61 provided in a block shape and configured to bury middle portions (portions at the rear side Y2 in the horizontal plate portion 2A) of the three terminals 2 in the front-rear direction Y, an air bleeding mechanism 62 provided in this burying portion 61, a cylindrical portion 63 that is continuously provided with this burying portion 61 at the front side Y1 and has an accommodation space S in which the terminals 2 are accommodated therein, and a flange portion 64 that extends in a flange shape at the rear side Y2 of the burying portion 61 and has a pair of bolt holes 6a, 6a (shown in FIG. 2).

As shown in FIG. 3, the burying portion 61 is provided with a packing accommodation portion 610 for accommodating the packing-for-retaining-portion 4 on an outer peripheral portion thereof. The packing accommodating portion 610 is provided in the front-rear direction Y at the front side Y1 of second passages 62B1, 62B2 in the air bleeding mechanism 62 described below. Also, the packing accommodation portion 610 is configured by cutting out the entire circumference of the outer peripheral surface of the burying portion 61 in a concave groove shape. This burying portion 61 is configured to be supported by being inserted into an assembly hole provided in a support body through the packing-for-retaining-portion 4 described below in a state in which the packing-for-retaining-portion 4 is accommodated in the packing accommodation portion 610.

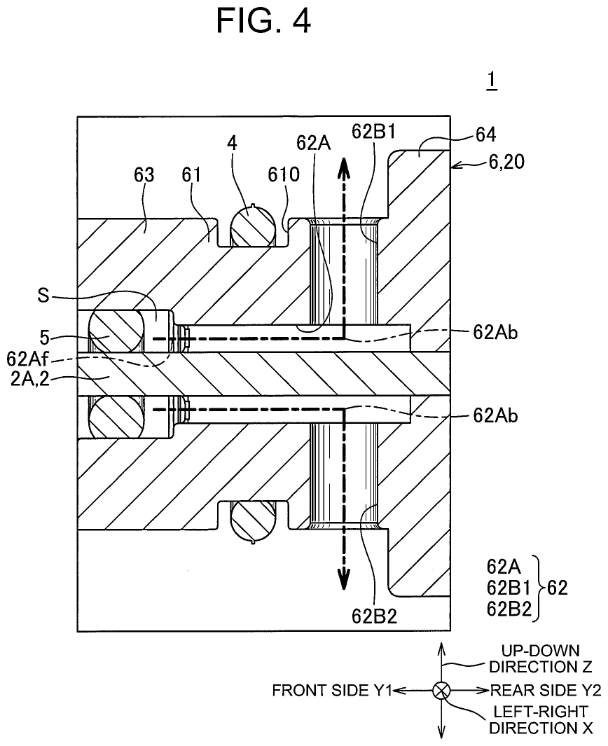

As shown in FIG. 3 and FIG. 4, the air bleeding mechanism 62 includes a first passage 62A provided around the terminal 2 with the front-rear direction Y as an axis, and a pair of second passages 62B1, 62B2 continuous with the first passage 62A. As shown in FIG. 4, the first passage 62A is provided with a front end 62Af (one end) communicating with the accommodation space S located inside the cylindrical portion 63 described below and to extend in a straight line toward the rear side Y2. The pair of second passages 62B1, 62B2 are configured to be continuous with the back end 62Ab (the other end) of the first passage 62A and to be provided at both ends to sandwich the terminal 2 to extend in a straight line in the up-down direction Z extending in the radial direction of the cylindrical portion 63. In this manner, the air bleeding mechanism 62 is configured to be able to discharge air inside the accommodation space S to the outside via the first passage 62A and the pair of second passages 62B1, 62B2.

As shown in FIG. 2 and FIG. 3, the cylindrical portion 63 is partitioned in the left-right direction X by two partition portions 65, and is configured to have three spaces (accommodating spaces S).

As shown in FIG. 2 and FIG. 3, the holder 3 includes a plate-shaped holder main body 31 that is in contact with the front-end surface of the cylindrical portion 63 in the resin molded portion 6 and has three terminal holes 30 in which the terminals 2 are inserted respectively, three insertion counterpart portions 32, each being provided in a cylindrical shape to be continuous with the inner circumferential surface of each terminal hole 30 of the holder main body 31 and inserted into each accommodation space S, and a plate-shaped insulation plate 33 protruding to the front side Y1 of this holder main body 31 and being provided between the terminal holes 30 that are adjacent to each other so as to insulate the terminals 2 from each other.

As shown in FIG. 2, the terminal packings 5 are provided in the same number (three) as that of the terminals 2. The terminal packing 5 is configured to be inserted to be outside the horizontal plate portion 2A of each terminal 2 and located inside the accommodation space S provided in the resin molded portion 6. Such terminal packing 5 is configured to be in close contact with each terminal 2 and the inner circumferential surface of each accommodation space S so as to prevent inundation at the rear side Y2 with respect to the accommodation space S.

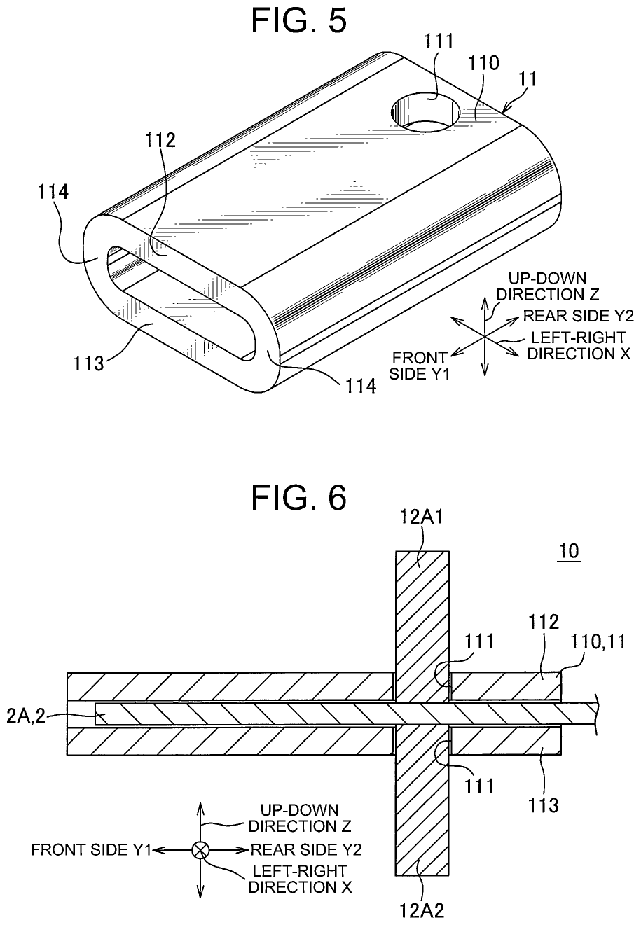

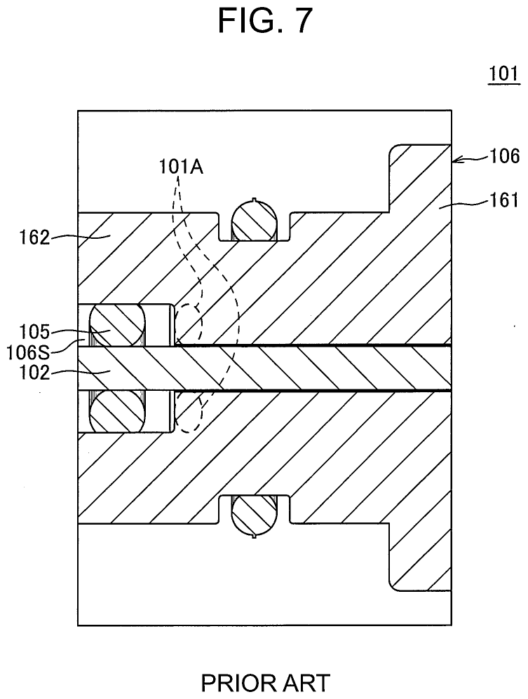

Next, a manufacturing apparatus 10 for manufacturing the terminal retaining portion 20 in the terminal block 1 will be described with reference to FIG. 5 and FIG. 6.

As shown in FIG. 5 and FIG. 6, the manufacturing apparatus 10 includes a mold (not shown in figures) for insert-molding three terminals 2 inside the resin molded portion 6, three of first inserts 11, each being inserted by the horizontal plate shape 2A of each terminal 2, and a pair of second inserts 12A1, 12A2 corresponding to each first insert 11. The mold is formed into a box shape capable of forming the resin molded part 6 while supporting the three terminals 2 at predetermined positions respectively.

As shown in FIG. 5, the first insert 11 is configured to include a cylindrical first insert main body 110 into which the terminal 2 is insertable, and a pair of insertion holes 111, 111 provided in this first insert main body 110 for inserting the pair of second inserts 12A1, 12A2 respectively. The first insert main body 110 is formed in a rectangular cylindrical shape to include an upper wall 112 and a lower wall 113 being opposite to each other in the up-down direction Z, and a pair of side walls 114, 114 being opposite to each other in the left-right direction X. This first insert main body 110 is configured that the horizontal plate shape 2A of the terminal 2 is inserted to the inside thereof.

As shown in FIG. 6, these pair of insertion holes 111, 111 are provided at the back end portion of the first insert main body 110. One of the pair of insertion holes 111, 111 is provided in the upper wall 112, and the other is provided in the lower wall 113. Also, the pair of insertion holes 111, 111 are provided, in each of the upper wall 112 and the lower wall 113, at the central portion in the left-right direction X (the central portion in the width direction), and are provided at positions being opposite to each other in the up-down direction Z.

As shown in FIG. 6, the pair of second inserts 12A1, 12A2 are provided in a rod shape and are configured to be insertable into the pair of insertion holes 111, 111 provided in the first insert 11, respectively. Such a pair of second inserts 12A1 and 12A2 are configured to inserted into the insertion holes 111 respectively to determine the position of each terminal 2 in the up-down direction Z in the state in which each terminal 2 is inserted into the first insert main body 110.

In a case of manufacturing the terminal retaining portion 20 using such a mold, the first insert 11, and the pair of second inserts 12A1, 12A2, the front end of each terminal 2 is brought to approach the back end of each first insert 11 and inserted therein. When each terminal 2 reaches a predetermined position, the insertion of each terminal 2 is stopped and the pair of second inserts 12A1, 12A2 are inserted into the pair of insertion holes 111, 111 respectively to vertically sandwich each terminal 2 by the pair of second inserts 12A1, 12A2 and determine the position of each terminal 2. In this state, the molten resin is poured into the mold and the resin is cured. Thereafter, the molded product is taken out from the mold, the pair of second inserts 12A1, 12A2 are drawn out from the pair of insertion holes 111, 111 respectively, each first insert 11 is moved to the front side Y1 of each terminal 2, and each first insert 11 is drawn out. In this manner, the first passage 62A is formed in the portion where the first insert 11 is provided, and the second passages 62B1, 62B2 are formed in the portions where the second inserts 12A1, 12A2 are provided. In this manner, the terminal retaining portion 20 into which each terminal 2 is inserted is formed.

Subsequently, in the case of assembling the terminal block 1, the terminal retaining portion 20, the holder 3, the packing-for-retaining-portion 4, and the terminal packing 5 are each manufactured in advance. The terminal retaining portion 20 is configured by insert molding three terminals 2 into the resin molded portion 6. That is, the three terminals 2 and the resin molded portion 6 are integrally constructed.

At first, the terminal packing 5 is inserted over the horizontal plate portion 2A of each terminal 2 provided in the terminal retaining portion 20, and the terminal packing 5 is moved to the rear side Y2 of the terminal 2. At this time, in the accommodation space S, the air at the rear side Y2 of the terminal packing 5 is discharged to the outside through the first passage 62A and the second passage 62B1, and also discharged to the outside through the first passage 62A and the second passage 62B2. In this manner, the terminal packing 5 is attached at a predetermined position of each terminal 2, and the accommodation space S is sealed by the terminal packing 5.

Thereafter, each insertion counterpart portion 32 of the holder 3 is brought to approach the tip of each terminal 2 and the holder 3 is moved to the rear side Y2 such that the terminal 2 is inserted into each insertion counterpart portion 32. As the movement progresses, the insertion counterpart portion 32 is accommodated in each accommodation space S. As the movement progresses further, the holder main body 31 comes into contact with the front-end surface of the cylindrical portion 63 in the resin molded portion 6. Thereafter, the packing-for-retaining-portion 4 is inserted to surround the terminal retaining portion 20 and the packing-for-retaining-portion 4 is housed in the packing accommodation portion 610. In this manner, the assembly of the holder 3 to the terminal retaining portion 20 is completed. This completes the assembly of the terminal block 1.

According to the embodiment described above, it is provided with the plate-shaped terminal 2, the terminal retaining portion 20 including the burying portion 61 into which part of the terminal 2 is buried, and the cylindrical portion 63 provided to be continuous with this burying portion 61 to surround the terminal 2, and the ring-shaped packing-for-terminal (packing) 5 to be inserted to surround the terminal 2 and to seal the accommodation space (internal space) S of the cylindrical portion 63, wherein the air bleeding mechanism 62 configured to discharge the air at the rear side Y2 (the side in the insertion direction of the packing-for-terminal 5) than the packing-for-terminal 5 in the accommodation space S is provided in the burying portion 61. According to this configuration, the air bleeding mechanism 62 is provided such that in the accommodation space S, the air at the rear side Y2 than the packing-for-terminal 5 is discharged to the outside through the air bleeding mechanism 62 (the air is bled). Accordingly, when each packing-for-terminal 5 is inserted to surround (inserted) each terminal 2, the insertion force when the packing-for-terminal 5 is inserted is decreased and it is possible to improve the assembly workability of the packing-for-terminal 5.

Moreover, the air bleeding mechanism 62 has the first passage 62A with the front end 62Af (one end) being provided to communicate with the accommodation space S (internal space) and extending to the rear side Y2 (the direction separating from the packing-for-terminal (packing) 5), and the second passages 62B1, 62B2 that are continuous with the back end 62Ab (other end) of the first passage 62A and extend in the radial direction of the cylindrical portion 63, the second passages 62B1, 62B2 are provided in a pair to sandwich the terminal 2 from both sides in the radial direction (up-down direction Z). When the terminal packing 5 is inserted to surround (inserted) the terminal 2, the configuration in which the insertion force when inserting the terminal packing 5 is reduced can be realized.

The manufacturing apparatus 10 for manufacturing the packing assembly body also includes the mold for inserting the terminal 2 and molding the terminal retaining portion 20, a first insert 11 in which the terminal 2 is inserted and configured for forming the first passage 62A, and a pair of second inserts 12A1, 12A2 for forming the pair of second passages 62B1, 62B2, wherein the pair of second inserts 12A1, 12A2 are provided in the rod shape, and the first insert 11 is configured to have the cylindrical first insert main body 110 in which the terminal 2 is insertable, and the pair of insertion holes 111, 111 being provided in this first insert main body 110 and in which the pair of second inserts 12A1, 12A2 are inserted respectively. Accordingly, at the time of the insert molding, the terminal 2 is sandwiched and supported by the pair of second inserts 12A1, 12A2 being inserted into the pair of insertion holes 111, 111 such that the positional accuracy of the terminal 2 is improved.

Further, the pair of insertion holes 111, 111 are provided at positions facing each other in the up-down direction Z (orthogonal direction being orthogonal to the axis of the first insert main body 110). According to this configuration, in the up-down direction Z, the positional accuracy of the terminal 2 in the terminal retaining portion 20 is improved.

Further, the pair of insertion holes 111, 111 are provided in the central portion in the left-right direction X (width direction being orthogonal to the axis of the first insert main body 110). According to this, the terminal 2 is stably supported within the mold by the pair of second inserts 12A1 and 12A2. Therefore, the positional accuracy of the terminals 2 in the terminal holding section 20 is further improved.

It is noted that the present invention is not limited to the embodiments described above, and other configurations that can achieve the object of the present invention are included, and the present invention also includes modification examples shown below.

In the above-described embodiment, the terminal block 1 including the terminal retaining portion 20 retaining three terminals 2, the holder 3 being assembled to the terminal retaining portion 20 to support each terminal 2, the ring-shaped packing-for-retaining-portion 4 interposed between this terminal retaining portion 20 and the peripheral edge of the assembly hole, and the ring-shaped terminal packing (packing) 5 attached to each terminal 2 is described as an example, however, the present invention is not limited thereto. It is sufficient if the configuration includes the packing assembly body having at least the terminal retaining portion 20 and the terminal packing 5. In this case, the holder 3 and the packing-for-retaining-portion 4 may be omitted.

Further, in the above-described embodiment, three terminals 2 are provided, however, the present invention is not limited thereto. It is sufficient that at least one terminal 2 is provided, and two, four or more terminals may be provided.

In the above-described embodiment, the air bleeding mechanism 62 is described to include the first passage 62A provided around the terminal 2 with the front-rear direction Y as the axis, and the pair of second passages 62B1, 62B2 being continuous with this first passage 62A, however, the present invention is not limited thereto. The air bleeding mechanism may be configured to include the first passage 62A and a single second passage that is continuous with the first passage 62A and extends in the radial direction of the cylindrical portion 63, for example, and for example when the number of terminals 2 is one or two, three or more second passages may be provided.

In addition, the best configuration, method and the like for carrying out the present invention have been disclosed in the above description, however, the present invention is not limited thereto. That is, although the present invention has been particularly illustrated and described primarily with respect to the particular embodiment, it is possible for a person with ordinary skill in the art to apply various modifications to the above-described embodiment in the detailed configuration such as shapes, materials, quantities and the like without departing from the scope of the spirit and purpose of the invention. Therefore, the descriptions that limit the shapes, materials and the like thereof disclosed above are provided as examples to facilitate understanding of the present invention, and do not limit the present invention such that descriptions in the names of members that exclude some or all of the limitations with respect to the shapes, materials and the like thereof are included in the scope of the present invention.

### REFERENCE SIGNS LIST

2 terminal
20 terminal retaining portion
5 terminal packing (packing)
61 burying portion
63 cylindrical portion
62 air bleeding mechanism
62A first passage
62Af front end of first passage (one end)
62Ab back end of first passage (other end)
62B1, 62B2 pair of second passages
10 manufacturing apparatus
11 first insert
110 first insert main body
111, 111 pair of insertion holes
12A1, 12A2 pair of second inserts
S accommodation space (internal space of cylindrical portion)
Z up-down direction (orthogonal direction being orthogonal to axis of first insert main body)
X left-right direction (width direction being orthogonal to axis of first insert main body)

What is claimed is:

1. A packing assembly body, comprising:
a terminal retaining portion including:
a plate-shaped terminal,
a burying portion in which part of the terminal is buried, and
a cylindrical portion being provided to continue with the burying portion to surround the terminal; and
a ring-shaped packing that is inserted to surround the terminal from the outside and seal an internal space of the cylindrical portion,
wherein an air bleeding mechanism configured to discharge air at the side of an insertion direction of the packing in the internal space to an outside is provided in the burying portion.

2. The packing assembly body according to claim 1,
wherein the air bleeding mechanism includes:
a first passage extending in a direction separating from the packing while being provided with an end communicating with the internal space; and
a second passage extending in a radial direction of the cylindrical portion and continuing with the other end of the first passage, and
a pair of the second passages are provided to sandwich the terminal at both sides in the radial direction.

3. A manufacturing apparatus for manufacturing the packing assembly body according to claim 2, comprising:
a mold for inserting the terminal to mold the terminal retaining portion;
a first insert for forming the first passage and in which the terminal is inserted; and
a pair of second inserts for forming the pair of second passages,
wherein the pair of second inserts are provided in a rod shape, and
the first insert is configured to include
a cylindrical first insert main body into which the terminal is insertable, and
a pair of insertion holes provided in the first insert main body and into which the pair of second inserts are inserted respectively.

4. The manufacturing apparatus according to claim 3, wherein the pair of insertion holes are provided at positions facing each other in an orthogonal direction that is orthogonal to an axis of the first insert main body.

5. The manufacturing apparatus according to claim 4, wherein the pair of insertion holes are provided in a central portion in a width direction that is orthogonal to the axis of the first insert main body.
